(19) United States
(12) Patent Application Publication
(10) Pub. No.: US 2002/0005621 A1
(43) Pub. Date: Jan. 17, 2002

(54) Control suspension arm for a motor vehicle

(76) Inventors: Wigbert Christophliemke, Schloss Holte-Stukenbrock (DE); Shaolin Wang, Paderborn (DE)

Correspondence Address: Henry M. Feiereisen, Suite 3220, 350 Fifth Avenue, New York, NY, 10118, US

(21) Appl. No.: 09/871,245

(22) Filed: May 31, 2001

(30) Foreign Application Priority Data
May 31, 2000 (DE) 200 096 95.8

(51) Int. Cl. B60G 3/04

(52) U.S. Cl. 280/124.134

(57) ABSTRACT

A control arm as suspension component for a motor vehicle, includes a hollow steel structure of steel sheets which are at least partially pressed and welded together, and a reinforcing sheet provided in a predetermined area of the steel structure for increasing a resistance against buckling.

### CROSS-REFERENCES TO RELATED APPLICATIONS

This application claims the priority of German Utility Model Application, Serial No. 200 09695.8, filed May 31, 2000, the subject matter of which is incorporated herein by reference.

### BACKGROUND OF THE INVENTION

The present invention relates, in general, to a control suspension arm for a motor vehicle.

Structural steel is typically used to date for making suspension components in the automobile industry. Apart from their costs and weight, structural steel forms a compromise between malleability and yield strength of steel, because an increase in yield strength is normally accompanied by a decrease in malleability of the steel.

Control arms have been typically configured as hollow steel structures in order to reconcile a higher demand on the suspension components with the limitations of installation space and/or desired weight reduction. Hereby, pressed parts, pipes or other profiled rods have been used, sometimes also in combination. Compared to massive structures, the use of hollow structures exhibits significantly better behavior under tensile stress and torsional stress while at the same time permits a weight reduction. However, such types of control arms oftentimes show a very critical buckling behavior, in particular when exposed to buckling loads in several directions.

It would therefore be desirable and advantageous to provide an improved control arm as suspension component for a motor vehicle, which obviates prior art shortcomings and exhibits significantly improved buckling resistance while yet exhibiting a slight weight and allowing installation in limited spaces.

### SUMMARY OF THE INVENTION

According to one aspect of the present invention, a control arm as suspension component for a motor vehicle, includes a hollow steel structure of steel sheets which are at least partially pressed and welded together, and a reinforcing sheet provided in a predetermined area of the steel structure for increasing a resistance against buckling.

Through the provision of at least partially pressed steel sheets of a configuration that can be suited to the respective function of a control arm, it is possible to improved the resistance against buckling by providing the hollow structure with an inner reinforcing sheet at those areas which are exposed to particular high degree of buckling loads. The reinforcing sheet is hereby disposed in a plane in which the buckling loads are encountered. Without appreciably increasing the weight and without restricting the available installation space in the suspension system, a control arm according to the invention can thus be subjected to a significantly higher degree of buckling loads.

According to another feature of the present invention, the control arm may be formed by a U-shaped troughed shell formed having a base and legs which extend from the base and terminate in free ends which are interconnected by a transverse sheet or a complementary U-shaped sheet, having opposite ends which are welded to the free ends of the shell, thereby bounding an interior space, wherein the reinforcing sheet is welded in the interior space between the legs. A higher twist stiffness and rigidity may be realized by forming crease-like depressions in the base or also in the legs of the U-shaped shell. The reinforcing sheets is welded to the legs of the shell before attachment of the transverse sheet of complementary sheet, and, like the transverse sheet or the web of the complementary sheet that closes the shell, may have a flat configuration, optionally with crease-like depressions.

Through integration of such reinforcement, the weight of a control arm according to the present invention can be reduced by up to about 15%, and the acceptable buckling loads can be increased by at least 15%.

According to another feature of the present invention, a control arm may be configured as a transverse control arm of substantial L-shape, with substantially two straight legs which are interconnected by a central curved length section. This length section is oftentimes in danger of buckling because this area serves as attachment of a rubber bearing. Therefore, the reinforcing sheet is suitably disposed in the area of the length section and welded thereto.

### BRIEF DESCRIPTION OF THE DRAWING

Other features and advantages of the present invention will be more readily apparent upon reading the following description of preferred exemplified embodiments of the invention with reference to the accompanying drawing, in which:

FIG. 1 is a schematic plan view of a transverse control arm as suspension component for a motor vehicle in accordance with the present invention;

FIG. 2 is a view of the control arm in the direction of arrow II of FIG. 1;

FIG. 3 is a sectional view of the control arm, taken along the line III-III in FIG. 1 in the direction of arrow IIIa;

FIG. 4 is a sectional view of the control arm, taken along the line IV-IV in FIG. 1 in the direction of arrow IVa; and

FIG. 5 is a sectional view of another embodiment of a control arm according to the present invention.

### DETAILED DESCRIPTION OF PREFERRED EMBODIMENTS

Throughout all the Figures, same or corresponding elements are generally indicated by same reference numerals.

Turning now to the drawing, and in particular to FIGS. 1 and 2, there are shown schematic illustrations of a control arm in the form of a transverse control arm, generally designated by reference numeral 1, for use as a suspension component for a motor vehicle in accordance with the present invention. The control arm 1 is formed as hollow steel structure and exhibits a substantially L-shaped configuration with two legs 2, 3 and an arched length section 4 between the legs 2, 3. At its length-section-distal end, the leg 2 has a receptacle 5 for attachment of a, not shown, ball-and-socket joint, whereas the leg 3 has a length-section-distal end formed with a receptacle 6 for a, not shown, rubber bearing. Projecting the outer periphery of the curved length section 4 is an extension 7 for attachment of a rubber bearing 8, shown only schematically.

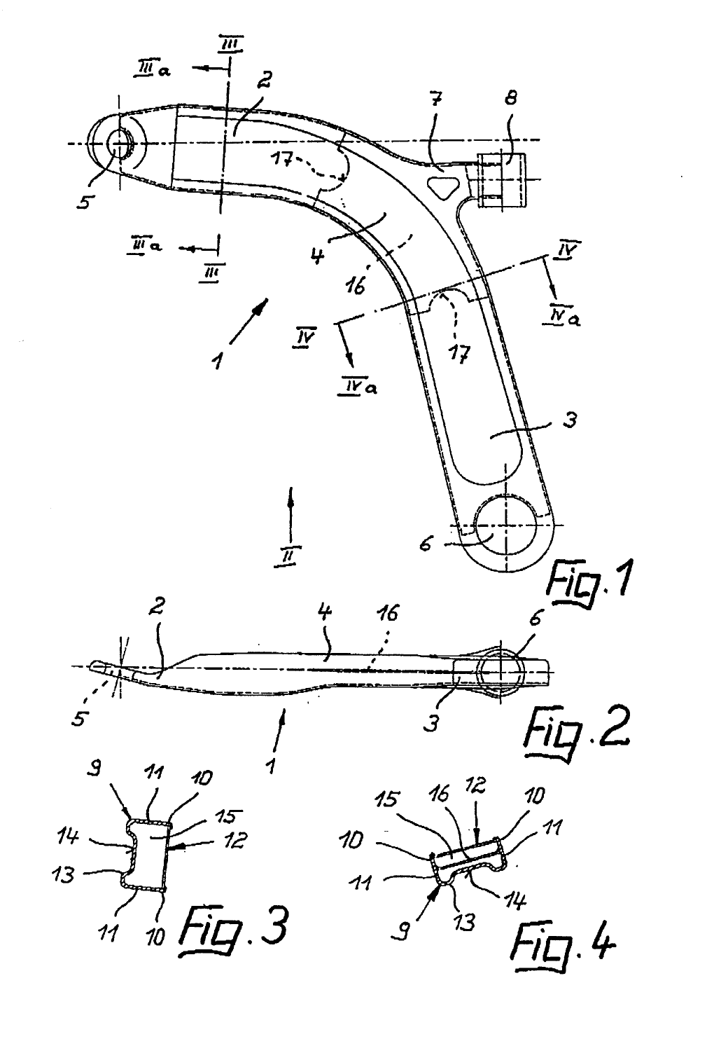

As shown in FIG. 3 and 4, the control arm 1 is comprised between the terminal receptacles 5, 6 of a U-shaped shell 9, which has opposite legs 11 interconnected by a base 13, and a flat transverse sheet 12 which extends between the legs 11 of the shell 9 and is welded to the free ends 10 of the legs 11 to thereby define an interior space 15. The base 13 of the shell 9 is formed with a longitudinal crease 14.

As shown in particular in FIG. 4, the control arm 1 is reinforced in the curved central length section 4 by a reinforcing sheet 16 which extends across the interior space 15 in a region between the base 13 of the shell 9 and the transverse sheet 12, and is welded at its ends to the legs 11. The reinforcing sheet 16 is attached to the legs 11 of the shell 9 before welding the transverse sheet 12. As shown in FIG. 1, the reinforcing sheet 16 is provided at its end faces with semi-round recesses 17.

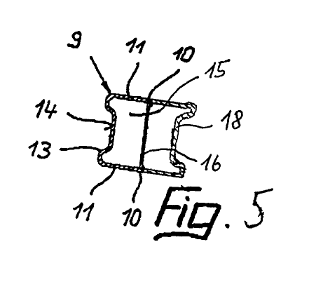

FIG. 5 shows another embodiment of a control arm 1. Parts corresponding with those in FIGS. 1 to 4 are denoted by identical reference numerals and not explained again. In this embodiment, provision is made for a complementary U-shaped shell 18, instead of a transverse sheet 12, for connecting the free ends 10 of the legs 11.

While the invention has been illustrated and described as embodied in a control suspension arm for a motor vehicle, it is not intended to be limited to the details shown since various modifications and structural changes may be made without departing in any way from the spirit of the present invention.

What is claimed as new and desired to be protected by Letters Patent is set forth in the appended claims:

What is claimed is:

1. A control arm as suspension component for a motor vehicle, comprising a hollow steel structure of steel sheets which are at least partially pressed and welded together, and a reinforcing sheet provided in a predetermined area of the steel structure for increasing a resistance against buckling.

2. The control arm of claim 1, wherein one of the steel sheets is formed by a U-shaped troughed shell having a base and legs extending from the base and terminating in free ends, wherein the other one of the steel sheets is formed as an element selected from the group consisting of a transverse sheet and a complementary U-shaped sheet, having opposite ends which are welded to the free ends of the shell, thereby bounding an interior space, wherein the reinforcing sheet is welded in the interior space between the legs.

3. The control arm of claim 1, configured as a transverse control arm of substantial L-shape, wherein the steel sheets are interconnected by a central curved mid-section, wherein the reinforcing sheet is welded to the length section.

4. The control arm of claim 2, wherein at least one of the base and legs of the shell has a crease-like depression for realizing an increased twist stiffness and rigidity.

5. The control arm of claim 1, wherein the reinforcing sheet has a crease-like depression for realizing an increased twist stiffness and rigidity.

6. A control arm for a suspension, comprising:
a first U-shaped shell having a base and legs extending from the base and terminating in free ends;
a connecting member having opposite ends which are welded to the free ends of the shell, thereby bounding an interior space; and
a reinforcing sheet welded in the interior space between the legs.

7. The control arm of claim 6, wherein the connecting member is a transverse sheet.

8. The control arm of claim 6, wherein the connecting member is a second U-shaped shell complementing the first U-shaped shell.
